(19) United States
(12) Patent Application Publication
(10) Pub. No.: US 2015/0379632 A1
(43) Pub. Date: Dec. 31, 2015

(54) BUSINESS METHOD FOR EFFICIENT AND DIRECT LOAN FINANCING

(71) Applicant: Joseph MICHAEL, Los Angeles, CA (US)

(72) Inventor: Joseph MICHAEL, Los Angeles, CA (US)

(21) Appl. No.: 14/320,616

(22) Filed: Jun. 30, 2014

(51) Int. Cl. G06Q 40/02; G06Q 30/02

(52) U.S. Cl. CPC G06Q 40/025; G06Q 30/0277; G06Q 50/167

(57) ABSTRACT

Disclosed herein are methods of loan financing within a computer-based membership club, comprising the steps of: a) establishing a loan financing membership club on a website on a computer-based network, wherein the membership club comprises at least one loan borrower, at least two lenders, and at least one loan evaluation/underwriting entity; b) accepting a loan application package from the borrower member on a website on a computer-based network; c) on the website, providing access to the loan application package to the loan evaluation entity, and receiving the loan application evaluation results from the loan evaluation entity; d) on the website, creating a loan application package, comprising the loan application package and the loan application evaluation results, and providing access to a completed fully underwritten the loan application package to the at least two lenders; e) on the website, accepting a lending bid from each of the lenders; f) on the website, providing access to the lending bids to the borrower; g) on the website, accepting the borrower's selection of the lending bid; and h) completing the loan funding and closing between the borrower and lender.

### FIELD OF THE INVENTION

The present invention relates to a computer-based membership club designed to increase the volume and efficiency of financial lending transactions between lenders and borrowers. In particular, the invention relates to a computer-based membership club comprising a computer-based network, lender members, borrower members, underwriters, and regulatory agencies such as FDIC. The membership club employs underwriters that are professionally trained to provide the lender members with a loan that is underwritten under a uniform market standards, thereby making the loan qualification process and lending more efficient and competitive between lender members and borrower members.

### BACKGROUND OF THE DISCLOSURE

Traditionally, real estate transactions, including financing are processed and closed between various potential players, including, among others, a borrower, buyer, seller, appraiser, financial entity or lender, loan broker, escrow officer, environmental consultants and an attorney.

With respect to purchasing and financing real estate, an important consideration is a favorable loan term and rate. However, at this time, most borrowers are limited to a few lending sources and, more specifically, after a financing application process begins with one lending source, the borrower technically is committed to the one lending source. The borrower does not have the ability to benefit from other more competitive loan programs that may be available from other lending sources, nor is there an efficient method of increasing exposure of a loan file to a larger pool of lenders. Also, lenders are typically limited to the borrowers and loan packages that are under application with them. They are not able to compete and fund loans that are fully underwritten meeting their lending criteria. Currently, there are numerous websites catering to real estate lending (e.g., Quickenloans, Intuit Inc., BankRate, Inc. and Lending Tree). However, these types of companies do not allow for multiple lenders to submit lending bids directly to a borrower from a single loan application that is fully packaged and underwritten under a uniform market standard in the primary mortgage market. The current system also does not allow borrowers to have their fully completed and underwritten loan package exposed to numerous lending sources for the best competitive loan programs. The primary mortgage market is defined as when an initial loan is made or funded between a lender and borrower. The secondary mortgage market is defined as the market for the sale of securities or bonds collateralized by value of mortgage loans or the sale of loans after it has been funded a lender in the primary mortgage market.

Every financial institution is regularly audited by agencies such as the FDIC (Federal Deposit Insurance Company), whereby each loan file on the lender's books is reviewed and audited. Based on audits, FDIC may impose a financial institution to hold funds or to increase its reserves for loans that do not meet the safety requirements imposed by FDIC. FDIC ensures that lenders have sufficient capital (capital ratio) to meet the minimum set by FDIC. The implementation of a uniform set of rules in the primary lending market, at the initial stage when loans are being underwritten by a primary underwriter benefits the efficiency of audits performed by the FDIC and improve the quality of loans made in the primary lending market, thus enhancing the stability of financial institutions and the overall financial marketplace.

Therefore, there is an unmet need in the financial lending market to make it possible for lenders to submit a direct offer or a bid for loan that is fully packaged and underwritten on a uniform market standard in the primary mortgage market. This can improve the volume of financial lending and make the process more efficient for lenders and borrowers at the same time, and implementing a financial lending method that is controlled and easily overseen and regulated, at the initial stages, by governmental regulatory agencies, such as the FDIC. In this aspect, there exists a need in the financing market to improve the volume of lending transactions and make the process more efficient for lenders, borrowers and regulatory agencies.

### SUMMARY OF THE INVENTION

Disclosed herein are methods of loan financing within a computer-based membership club, comprising the steps of: a) establishing a loan financing membership club on a website on a computer-based network, wherein the membership club comprises at least one loan borrower, at least two lenders, and at least one loan evaluation/underwriting entity; b) accepting a loan application package from the borrower member on a website on a computer-based network; c) on the website, providing access to the loan application package to the loan evaluation entity, and receiving the loan application evaluation results from the loan evaluation entity; d) on the website, creating a loan application package, comprising the loan application package and the loan application evaluation results, and providing access to a completed fully underwritten the loan application package to the at least two lenders; e) on the website, accepting a lending bid from each of the lenders; f) on the website, providing access to the lending bids to the borrower; g) on the website, accepting the borrower's selection of the lending bid; and h) completing the loan funding and closing between the borrower and lender.

### BRIEF DESCRIPTION OF THE DRAWINGS

FIG. 1 is a flowchart depicting the financing marketplace of the membership club and the use of one unified loan file to submit to one or more lender members, wherein each lender member may submit a lending bid based upon the same loan file.

FIG. 2 is an illustration of the computer-based network depicting the flow of information within the membership club between borrower members and lender members over the over a computer-based network via the internet. Pathway 1 involves transmitting a loan package and desired financing to the membership club and receiving lending bids from the lender member via the membership club. Pathway 2 involves receiving loan files from the membership club and transmitting lending bids to the borrower member via the membership club.

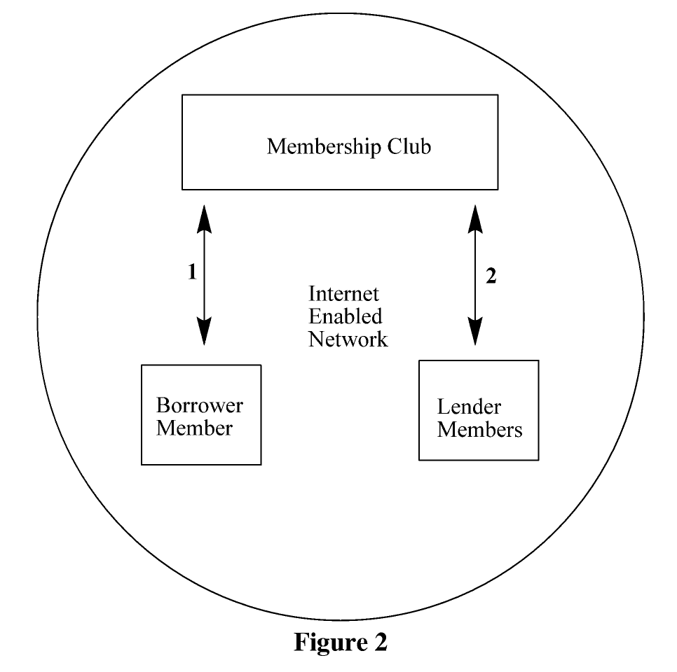

### DETAILED DESCRIPTION OF THE EMBODIMENTS

The following is a detailed description of certain specific embodiments of the methods disclosed herein. In this description reference is made to the drawings. For convenience the present disclosure is organized stepwise in a way that corresponds approximately to the steps in the financing method herein.

### Definitions

The term “borrower member”, refers to an individual, group, corporate entity or other business, or any entity capable of borrowing funds that is a member of the membership club herein.

The term “lender member”, refers to an individual, group, corporate entity, financial institution (e.g., a bank, investment firm or other business), a government institution, or any entity capable of lending funds, that is a member of the membership club herein.

The term “loan application package”, refers to required documentation and verification information that the borrower member needs to submit to the membership club to meet requirements for the membership club's underwriters to submit a loan file that is approved, fully packaged and underwritten under a uniform market standard to lender members in the membership club. For example, these requirements within residential mortgages could change given future amendments within the financial lending regulations, but in general may include the following for a residential real estate loan:
Completed and signed Residential Mortgage Application form.
Residential Mortgage Credit Report.
Income/employment documentation, which may include:
   Verification of Employment.
   Pay stub(s) indicating year-to-date earnings.
   W-2 forms.
   Tax returns.
   IRS Form 4506-T.
   Other—Documentation to evidence of other qualifying income.
Asset documentation per underwriting requirements:
   Verification of Deposit (VOD) showing average balances for a length of time, for example two months.
   Bank statements.
   Gift letter.
   Other—Documentation to evidence other assets, as applicable.
Verification of rent or mortgage.
Underwriting Report.
Fully executed sales contract.
Full Uniform Residential Appraisal Report.
Other information pertinent to the underwriting decision.
Escrow instructions.
Preliminary title report.

For example, these requirements within commercial mortgage financing subject to change given future amendments within the financial lending regulations, but in general may include the following:
Current rent roll.
Income and expense statement for the property for prior year.
Year-to-date income and expense statement for the property.
3 years tax returns on borrowing entity.
3 year tax returns for individuals.
Environmental Questioner.
Current Financial Statement.
Credit reports.
Loan Application.
Appraisal report.
Environmental report.
Lease agreements.
Escrow instructions.
Preliminary title report.

For example, these requirements for an auto loan subject to change given future amendments within the financial lending regulations, but in general may include credit application; Vehicle Identification Number (“VIN”), or credit reports.

The term “underwriting”, refers to for example a detailed credit analysis preceding the granting of a loan, or a property analysis for the collateral. Among other criteria, the underwriting is based on information furnished by the borrower as well as information obtained from third parties such as credit bureaus, appraisal reports, environmental reports, cities or municipalities, such as zoning reports. Underwriting also may include: the verification of such items as employment history, liquid assets, salary and financial statements; publicly available information, such as the borrower's credit history, which is detailed in a credit report; and the lender's evaluation of the borrower's credit needs and ability to pay the loan. Examples include mortgage underwriting. Commercial or business underwriting consists of the evaluation of financial information provided by small businesses including analysis of the business balance sheet including tangible net worth, the ratio of debt to worth and available liquidity. Analysis of the income statement typically includes the revenue, gross margin, profitability, and debt service coverage ratio.

The term “loan evaluation entity,” which is synonymous with “underwriter,” refers to the entity that conducts the underwriting.

The term “loan application evaluation results” refers to the results of the underwriting by the underwriter.

The term “completed loan package” refers to a file containing, among others, the loan application package and the loan application evaluation results. The completed loan package is the information that is available to the lenders. The lenders base their bids on the information contained in the completed loan package.

The term “computer-based network”, refers to a telecommunications network that allows computers to exchange data. In this aspect, networked computing devices may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of a computer network. Two such devices are said to be networked together when one device is able to exchange information with the other device, whether or not they have a direct connection to each other. The best-known computer network is the Internet. Computer networks support applications such as access to the World Wide Web and the Cloud, shared use of application and storage servers, printers, and fax machines, and use of email and instant messaging applications.

The term “lending bid”, refers to an offer from the lender member that includes all the loan terms and conditions needed to close the loan (i.e., loan amortization, loan terms, loan amount, loan interest rate, loan fees and any other conditions required to close said loan).

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

### Introduction

In one aspect, disclosed herein are methods of loan financing within a computer-based membership club, comprising the steps of:
a) establishing a loan financing membership club on a website on a computer-based network, wherein the membership club comprises at least one loan borrower, at least two lenders, and at least one loan evaluation entity;
b) accepting a loan application package from the borrower member on a website on a computer-based network;
c) on the website, providing access to the loan application application package to the loan evaluation entity, and receiving the loan application evaluation results from the loan evaluation entity;
d) on the website, creating a completed loan application package, comprising the loan application package and the loan application evaluation results, and providing access to a completed loan package, which includes all the information necessary for funding a loan to the at least two lenders;
e) on the website, accepting a lending bid from each of the lenders;
f) on the website, providing access to the lending bids to the borrower; and
g) on the website, accepting the borrower's selection of the lending bid; and
h) on the website, completing and closing the loan.

In some embodiments, a list of required information and documents for the loan application package is provided on the computer-based network by the loan evaluation entity. In certain embodiments, the loan application package is a complete loan package meeting all the requirements needed to underwrite the loan under a uniform market standard.

In some embodiments, the loan evaluation entity employs a process for acquiring real estate property appraisals or any other documentation needed to close the loan based upon the requirements of the selected lending member. In certain embodiments, the loan application package further comprises a property address, a desired loan term, a desired loan amount, a desired interest rate for at least one property, optionally a purchase price for said property, and optionally desired fees and costs. In further embodiments, the loan application package for each borrower member is stored electronically within the computer-based network with the membership club and can be accessed and updated in one or more successive loans.

In some embodiments, the borrower is provided unlimited opportunity to update the loan application package, wherein the updating comprises replacing outdated information in the loan application package stored electronically within the computer-based network with the membership club. In these embodiments, the borrower may complete one loan application, for example, for the purchase of one property, and then use the same loan application in a few months to buy or refinance a second property. The borrower will then only need to access the original application and modify it by adding or uploading new information or replacing outdated information, such as the primary address, the annual income, age, tax returns, etc., of the borrower.

In some embodiments, the loan application evaluation results further comprises a loan qualification rating between about 1 to 10 where a rating of 10 represents a better qualified loan than a rating of 1. In some embodiments, certain lenders only would entertain loan applications that have received a high rating, for example a rating of 8 and above, whereas other lenders entertain loans that are of lesser quality, and have a lower rating, for example 5 and above. Each lender can then decide which loan applications it entertains when matching its risk criteria with the loan application rating.

In certain embodiments, the lending bid further comprises all the loan terms and conditions required to close a loan. In further embodiments, the loan terms and conditions comprise loan amortization, loan terms, loan amount, loan interest rate, loan fees and any other conditions required to close a loan. In yet other embodiments, the membership club comprises at least 1, 2, 3, 4, 5, 6, 7, 8, 9 or 10 different lender members and each lender member submits at least 1, 2, 3, 4, 5, 6, 7, 8, 9 or 10 different lending bids.

In some embodiments, the membership club provides for a competitive bidding platform on a website over the computer-based network, whereas in other embodiments, the bidding is not competitive.

In some embodiments, the borrower member has a finite amount of time to select a desired lending bid, wherein the amount of time is less than about 7 days, 14 days, 21 days or 28 days.

In certain embodiments, the membership club further comprises a communication platform on the website that allows lender members to advertize the lending bids to borrower members. In some of these embodiments, the communication platform comprises a method of communication selected from the group consisting of mobile phone text messaging, telephone voice messaging, email, and instant messaging over the computer-based network.

In some embodiments, the above methods further comprise the steps of processing the loan transaction in compliance with state and federal regulations, approving the loan transaction and funding the loan transaction.

In some embodiments, the lending bid is provided for real estate financing, auto loan financing, motorcycle loan financing, watercraft loan financing and consumer credit transactions. In some of these embodiments, the borrower member's financing requirements for auto loan financing, motorcycle loan financing and watercraft loan financing comprise a year, make and model, a purchase price, a desired loan term, a desired loan amount and a desired interest rate. In other embodiments, the borrower member's financing requirements for the consumer credit transaction comprises a desired loan term, a desired loan amount and a desired interest rate.

In some embodiments, a governmental regulatory agency, for example the FDIC, audits the completed loan package. By way of the audit, the agency ensures that the loan application meets the minimum standards.

In some embodiments, the governmental regulatory agency provides the uniform market standards for underwriting and qualifying of a loan application.

In another aspect, disclosed herein are methods of loan financing within a computer-based membership club, comprising the steps of: a) creating a loan application package by a borrower member on a website on a computer-based network; b) submitting the loan application package of Step a) by the borrower member to a loan evaluation entity on a website over the computer-based network; c) creating a loan file by the loan evaluation entity from the loan application package of Step b) that is approved, fully packaged and underwritten under a uniform market standard on a website on the computer-based network; d) submitting a loan file of Step c) by the loan evaluation entity to at least one lender member on a website over the computer-based network; e) preparing a lending bid in view of the loan file of Step d) by at least one lender member on a website on the computer-based network; f) submitting the lending bid of Step e) by the lender member to the borrower member directly or via the loan evaluation entity on a website over the computer-based network; and g) selecting a lending bid by the borrower member based upon the borrower member's desired financing requirements on a website on the computer-based network, wherein the membership club comprises: i. at least one borrower member; ii. at least one lender member; iii. the loan evaluation entity comprising at least one professional loan underwriter; iv. at least one membership club website accessed by the borrower member, lender member and the loan evaluation entity over the computer-based network, and wherein each lending bid of Step e) is derived from one loan file for each borrower member.

In some embodiments, the list of required information and documents for the loan application package are provided on the computer-based network by the loan evaluation entity.

In certain embodiments, the loan application package of Step a) is a complete loan package meeting all the requirements needed to underwrite the loan under a uniform market standard.

In certain embodiments, the loan application package of Step a) is a complete loan package meeting all the requirements needed to fund a loan by a lending member.

In some embodiments, the loan evaluation entity employs a process for adding new members comprising borrower members and lender members on a website over the computer-based network.

In some embodiments, the loan evaluation entity employs a process for acquiring real estate property appraisals or any other documentation needed to close the loan based upon the requirements of a typical lending bid.

In some embodiments, the professional loan underwriter is trained to follow the FDIC lending guidelines.

In some embodiment, regulatory agencies such as FDIC oversees the loan underwriting process.

In some embodiments, the borrower member's financing requirements further comprise a property address, a purchase price for said property, a desired loan term, a desired loan amount and a desired interest rate for at least one property.

In some embodiments, the loan file of Step c) for each borrower member is stored electronically within the computer-based network with the membership club and can be accessed and updated in one or more successive loans.

In some embodiments, updating the loan file comprises replacing outdated information in the loan file stored electronically within the computer-based network with the membership club.

In some embodiments, the loan file of Step c) is in the form of a summary or complete loan file.

In some embodiments, the loan file further comprises a loan qualification rating between about 1 to 10.

In some embodiments, the lending bid of Step g) further comprises all the loan terms and conditions required to close a loan.

In some embodiments, the loan terms and conditions comprise loan amortization, loan terms, loan amount, loan interest rate, loan fees and any other conditions required to close a loan.

In some embodiments, Step f) comprises at least 1, 2, 3, 4, 5, 6, 7, 8, 9 or 10 or more different lending bids submitted by each lender member.

In some embodiments, Step f) further comprises at least 1, 2, 3, 4, 5, 6, 7, 8, 9 or 10 or more different lender members.

In some embodiments, Step f) further comprises at least 1, 2, 3, 4, 5, 6, 7, 8, 9 or 10 or more different lender members and each lender member submits at least 1, 2, 3, 4, 5, 6, 7, 8, 9 or 10 or more different lending bids.

In some embodiments, the membership club provides for a competitive bidding platform on a website over the computer-based network.

In some embodiments, Step d) further comprises an amount of time to select a desired lending bid by the borrower member that is less than about 7 days, 14 days, 21 days or 28 days.

In some embodiments, the membership club further comprises a communication platform on a website over the computer-based network that allows lender members to advertize said lending bids to borrower members.

In some embodiments, the communication platform comprises mobile phone text messaging, telephone voice messaging and email and instant messaging over the computer-based network based upon the borrower member's submitted loan application package.

In some embodiments, the disclosed methods further comprise the steps of processing the loan transaction in compliance with state and federal regulations, approving the loan transaction and funding the loan transaction.

In some embodiment, the membership club has the capability of completing funding a loan between a borrower member and lender member based on the terms of a selected bid, similar to the function of an escrow company.

In some embodiment, the membership club has the capability of providing title insurance policy to close and fund a loan based on the requirements of a selected bid, similar to the function of an title insurance company.

In some embodiments, the lending bid is provided for real estate financing, auto loan financing, motorcycle loan financing, watercraft loan financing, consumer credit transactions, and the like.

In some embodiments, the borrower member's financing requirements for auto loan financing, motorcycle loan financing and watercraft loan financing comprise a year, make and model, a purchase price, a desired loan term, a desired loan amount and a desired interest rate.

In some embodiments, the borrower member's financing requirements for the consumer credit transaction comprises a desired loan term, a desired loan amount and a desired interest rate.

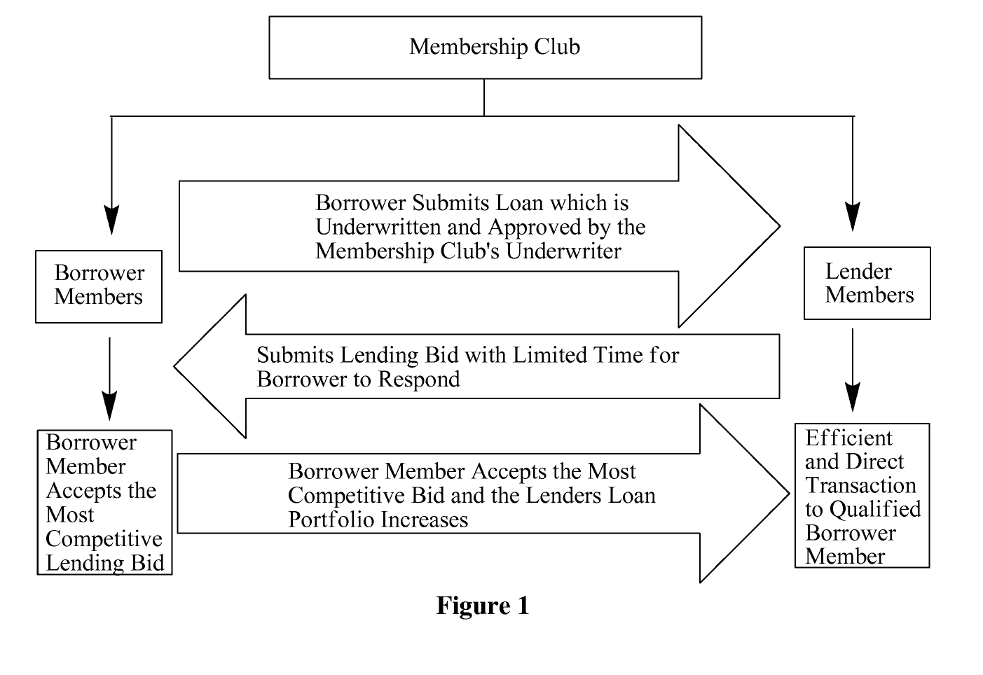

FIG. 1 illustrates an embodiment of a method for a financial marketplace that is capable of utilizing the disclosed method for improving the efficiency and volume of lending transactions. The disclosed method can be used by or in connection with a lender member as a financial institution, for example a bank, investment firm or other business, or a government institution. The method illustrated in FIG. 1 includes a borrower member as an individual, group of individuals, corporate entity or other business, or any entity legally able to borrow funds. Moreover, the method illustrated in FIG. 1 employs a membership club, whereby borrowers and lenders become members of the club. The membership club employs professionally trained loan underwriters and a means of adding new borrower members and lender members.

Currently, there are numerous websites catering to real estate financial lending (e.g., Quickenloans, Intuit Inc., BankRate, Inc., Lending Tree, etc.). However, while these online sites and financial institutions are able to present a trove of information to borrowers, including various interest rates and programs, it is not possible for lender members to submit a direct offer or a bid for a loan that is fully packaged and underwritten on a uniform market standard method in the primary mortgage market. In this aspect, the advantage of the presently disclosed methods is to make it possible for lender members to submit a direct offer or a bid for a loan that is fully packaged and underwritten to a borrower. Moreover, the presently disclosed methods can used to supplement the previously mentioned websites and financial institutions to improve volume of transactions and make the process more efficient for lenders, borrowers and the regulatory agencies which include bank auditors.

As illustrated in FIG. 1, the presently disclosed methods pertain to a membership club where a borrower member may first establish their qualifications and desired financing and then submit all required documents necessary to complete the loan package for approval and funding. The membership club then may submit an offering either in a form of a summary or a complete loan file to various lender members or a completed fully underwritten loan file. These lender members submit a lending bid via the membership club to the borrower member. The lending bid includes all the terms and conditions, such as amortization, loan terms, loan amount, loan interest rate, and any fees or any other conditions. This method with the membership club gives the lender member with the most competitive lending bid who has lowest cost of funds and biggest desire to increase its loan portfolio. Therefore, the most competitive lender members gain the largest market share, which has the effect of optimizing the lending marketplace by stimulating competition.

In real estate financing transactions, in addition to assessing the borrower, the property itself is scrutinized. Underwriters employed by the membership club may use the debt service coverage ratio to figure out whether the property is capable of redeeming its own value and the membership club could request an appraisal of the subject property.

The membership club employs professionally trained underwriters who follow lending guidelines from the FDIC. Information received from borrower members and lender members is confidential, safe and secure on client servers and/or the Cloud with the membership club management team.

As a borrower member is established by one or more loans over time, each returning borrower member becomes an established borrower member. In this aspect, the borrower member's loan history and previously submitted loan packages simplify the process to obtain new loan(s) that are packaged, approved and underwritten by the membership club underwriters. In some cases successive loan applications from a particular borrower member involve updating the previous loan file. Therefore, the lending system via the membership club is more uniform and streamlined. Moreover, the borrower member may submit one loan package that is underwritten under and via the membership club receive multiple lending bids, which reduce the burden on borrowers, lenders and regulatory agencies.

The membership club then gives a borrower member a rating of 1 to 10 based upon their creditworthiness, income ratio and financial position or other criteria such as the collateral or the property. The rating accompanies the loan file sent to the lender members. The rating defines 10 as most desirable and 1 as least desirable in terms of the stated criteria.

Therefore, given the previous embodiments discussed herein the lending process is more efficient and direct. This method allows a borrower member to receive the best lending bid from a lender member as part of the membership club. Furthermore, this method allows a lender member to efficiently complete funding for a loan by relying on the loan file that is fully packaged and underwritten on a uniform market standard. Lenders may become members of the membership club and ultimately, may eliminate all their in-house underwriters and loan processors and rely on a fully packaged loan file by a central underwriting entity which is one of the functions of the membership club.

The membership club with the use of a loan file that is fully packaged and underwritten on a uniform market standard allows lender members to advertize in real time, all through a single interface and invite borrower members to accept bids within a specified timeframe.

This presently disclosed methods allow borrower members to finance properties at the most competitive prices. They allow lender members to invest in mortgages based on uniform standards, approved and overseen by FDIC. They substantially reduce future audits by FDIC, as they are involved during the processing of initial loan package. They greatly increase liquidity to the mortgage marketplace as there are no limits as to who can participate. All of these variables create a more streamlined and efficient way of doing business. Using this way of doing business, it is very difficult for small or large financial institutions to avoid joining the membership club, since the borrower members find it more beneficial to do business through the membership club.

This real-time loan bidding by lender members with the ability to connect with borrower members will dramatically improve efficiency, the economy and time allocated for searching for financing and possibly avoiding the middleman brokers and in-house loan officers. Lender members are able to transmit information or lending bids to borrower members regarding any financing desired by a borrower member through the membership club. Moreover, this method can be applied to any types of loans such as a real estate financing or refinancing, auto, motorcycle and watercraft loan financing, and consumer credit transactions.

Moreover, targeting borrower members within a desired range has a capability to directly send its targeted advertisement to a borrower member to satisfy an immediate and specific need for financing. Lender members can submit a text message, voice message, video, image, and digital message with a quick eye-catching advertisement to a borrower member based upon criteria set forth by the borrower member.

The presently disclosed methods are not to be limited in scope by the specific embodiments described herein, which are intended as single illustrations of individual aspects of the presently disclosed methods, and functionally equivalent methods and components are within the scope of the presently disclosed methods. Indeed, various modifications of the presently disclosed methods, in addition to those shown and described herein will become apparent to those skilled in the art from the foregoing description and accompanying drawings. Such modifications are intended to fall within the scope of the appended claims.

What is claimed is:

1. A method of loan financing within a computer-based membership club, comprising the steps of:
a) establishing a loan financing membership club on a website on a computer-based network, wherein the membership club comprises at least one loan borrower, at least two lenders, and at least one loan evaluation entity;
b) accepting a loan application package from the borrower member on a website on a computer-based network;
c) on the website, providing access to the loan application package to the loan evaluation entity, and receiving the loan application evaluation results from the loan evaluation entity;
d) on the website, creating a completed loan package, comprising the loan application package and the loan application evaluation results, and providing access to the completed loan package to the at least two lenders;
e) on the website, accepting a lending bid from each of the lenders;
f) on the website, providing access to the lending bids to the borrower;
g) on the website, accepting the borrower's selection of the lending bid; and
h) on the website, completing and closing the loan.

2. The method of claim 1, wherein a list of required information and documents for the loan application package is provided on the computer-based network by the loan evaluation entity.

3. The method of claim 1, wherein the loan application package is a complete loan package meeting all the requirements needed to underwrite the loan under a uniform market standard.

4. The method of claim 1, wherein the loan evaluation entity employs a process for acquiring real estate property appraisals or any other documentation needed to close the loan based upon the requirements of the selected lending member.

5. The method of claim 1, wherein the loan application package further comprises a property address, a desired loan term, a desired loan amount, a desired interest rate for at least one property, optionally a purchase price for said property, and optionally desired fees and costs.

6. The method of claim 1, wherein the loan application package for each borrower member is stored electronically within the computer-based network with the membership club and can be accessed and updated in one or more successive loans.

7. The method of claim 1, wherein the borrower is provided unlimited opportunity to update the loan application package, wherein the updating comprises replacing outdated information in the loan application package stored electronically within the computer-based network with the membership club.

8. The method of claim 11, wherein the loan application evaluation results further comprises a loan qualification rating between 1 to 10, wherein a rating of 10 represents a better qualified loan than a rating of 1.

9. The method of claim 1, wherein the lending bid further comprises all the loan terms and conditions required to close a loan.

10. The method of claim 9, wherein the loan terms and conditions comprise loan amortization, loan terms, loan amount, loan interest rate, loan fees and any other conditions required to close a loan.

11. The method of claim 1, wherein the membership club comprises at least 1, 2, 3, 4, 5, 6, 7, 8, 9 or 10 different lender members and each lender member submits at least 1, 2, 3, 4, 5, 6, 7, 8, 9 or 10 different lending bids.

12. The method of claim 11, wherein the membership club provides for a competitive bidding platform on a website over the computer-based network.

13. The method of claim 1, wherein the borrower member has a finite amount of time to select a desired lending bid, wherein the amount of time is less than about 7 days, 14 days, 21 days or 28 days.

14. The method of claim 1, wherein the membership club further comprises a communication platform on the website that allows lender members to advertize the lending bids to borrower members.

15. The method of claim 15, wherein the communication platform comprises a method of communication selected from the group consisting of mobile phone text messaging, telephone voice messaging, email, and instant messaging over the computer-based network.

16. The method of claim 1, further comprising the steps of processing the loan transaction in compliance with state and federal regulations, approving the loan transaction and funding the loan transaction.

17. The method of claim 17, wherein the borrower member's financing requirements for the consumer credit transaction comprises a desired loan term, a desired loan amount and a desired interest rate.

18. The method of claim 1, wherein a governmental regulatory agency audits the completed loan package.

19. The method of claim 1, wherein a governmental regulatory agency audits the underwriting process.

20. The method of claim 3, wherein the uniform market standards are provided by a governmental regulatory agency.

21. The method of claim 1, wherein the loan is for a financing selected from the group consisting of real estate financing, auto loan financing, motorcycle loan financing, watercraft loan financing, and consumer credit transactions.
